(19) United States
(12) Patent Application Publication
(10) Pub. No.: US 2015/0324897 A1
(43) Pub. Date: Nov. 12, 2015

(54) INTERNET VENDING MACHINE/MOBILE VENDING MACHINE SYSTEM AND METHOD

(71) Applicant: Content Delivery Ads, Inc., Tucson, AZ (US)

(72) Inventors: Carl V. VENTERS, III, Wilmington, NC (US); Eugene B. PHILLIPS, II, Raleigh, NC (US); Gary BLAKELY, Sherman Oaks, CA (US); Addison HARDY, San Francisco, CA (US)

(21) Appl. No.: 14/805,875

(22) Filed: Jul. 22, 2015

Related U.S. Application Data
(63) Continuation of application No. PCT/US2014/015031, filed on Feb. 6, 2014.
(60) Provisional application No. 61/761,597, filed on Feb. 6, 2013.
(60) Provisional application No. 61/906,013, filed on Nov. 19, 2013.

(51) Int. Cl. G06Q 30/06; G06Q 50/00; G06Q 30/02; G06Q 20/12

(52) U.S. Cl. CPC G06Q 30/0643; G06Q 20/123; G06Q 50/01; G06Q 30/0253

(57) ABSTRACT

A system and method of creating, publishing and distributing display advertising for products sold by online merchants. The system provides tools for individuals with limited experience in the online marketing industry to create and publish customized and personalized display advertising for these products and distribute this display advertising and links to the products by multiple methods. These distribution methods enable users of the system to take full advantage of recommendation based marketing as well as push products ads and links directly to user devices such as smart phones and mobile devices of potential customers. This allows individuals to participate in a plurality of affiliate marketing programs of multiple online merchants on a single platform. Further, the platform enables the secure distribution of digital content via its legacy rights management IP and software.

This application is a Continuation of PCT/US2014/015031, filed Feb. 6, 2014, which claims benefit and priority to U.S. Provisional application No. 61/761,597, filed Feb. 6, 2013 and U.S. Provisional application No. 61/906,013, filed Nov. 19, 2013, the disclosures of which are incorporated by reference herein.

### BACKGROUND OF THE INVENTION

1. Field of the Invention

The present disclosure generally relates to mobile, internet marketing and recommendation based social media advertising and marketing of products and services, and, more specifically, to a system and method for direct sales of products from individuals, manufacturers, distributors or the like. These products may include self-promoted products and also those from affiliate marketing programs which use display advertising and product link distribution to sell products from online merchants and retailers.

2. Background Description

In the modern recommendation and trust-based marketplace, individuals are always looking for ways to monetize their ideas and products, which may be both physical goods and original digital content. Online merchants and retailers are also looking for ways to drive more potential customers to their product sales websites such as on the Internet. They may do this via direct sales from their ecommerce websites or through affiliate marketing programs that were created to harness large numbers of independent marketers as a secondary sales force to help merchants accomplish this goal.

Affiliate marketing programs reward affiliates for each visitor or customer attracted by the affiliate's own marketing efforts. To attract these customers, the affiliate marketer uses various methods to distribute links to the merchant website. These methods may include placing banner ads on various third-party content websites, promoting links on search engine results, placing links on blogs and in articles, distributing links by email and placing links on coupon and rebate websites. Affiliate programs typically have their own member requirements that are different from one another which makes it even more difficult for new users to participate.

Compensation has been earned by the affiliate marketer by several methods, including, e.g., costs per click (CPC), costs per action (CPA) and revenue sharing or pay per sale (PPS.) With the costs per click and cost per action method, the merchant measures the number of visitors generated to the retail site website and actions they take, such as filling out a form or registering for a newsletter, and may pay the affiliate accordingly. Since these actions do not necessarily result in a purchase, most merchants now reward their affiliate marketers by the pay-per-sale method which pays the affiliate a commission on each purchase or a “conversion” as determined by affiliate marketer that is made by the new customer.

Individuals new to promoting their own products or new to the affiliate marketing industry encounter some daunting issues when they get started. The first of these is choosing an efficient way promote their own products or selecting an affiliate program and going through the process of applying and being accepted as a member of that program. Some programs are easier to join than others with some programs even requiring the applicant to provide a URL to an existing website that they own in order to qualify.

Another problem is dealing with the technology involved with promoting products on the Internet and/or engaging with the affiliate marketing industry. This problem is shared by manufacturers and distributors who want to engage in ecommerce of any kind. The technical side of mounting products, creating affiliate links or working with banner ad HTML code is a hurdle for many people when they first get into ecommerce and affiliate marketing. Many new to the industry are also frustrated by the prospect of purchasing a domain for their affiliate marketing site and then having to go through the process of building that site.

Understanding the world of Search Engine Optimization (SEO) and Search Engine Marketing (SEM) can be a problem not only for the beginner affiliate marketer, but for those with experience in the industry as well. Understanding the technical aspects of achieving high page rankings in search engine results, such as key word generation and optimizing HTML page elements, can be a time consuming and frustrating process.

Ecommerce and affiliate marketers must also figure out how to best promote their products by distributing ads and products links to potential customers. This involves all of the methods that have traditionally been used to distribute ads and links as well as new methods which take advantage of the recommendation and trust-based marketing environment of social networks and information distribution networks. Individuals and affiliate marketers also need an efficient method of pushing ads and links to mobile devices.

These above barriers and difficulties if overcome may permit more access to affiliate marketing and promotion of products for sale, as well of new opportunities for promoting and selling new products on-line.

### SUMMARY OF THE DISCLOSURE

In one aspect, a system and method of creating, publishing and distributing display advertising for products sold by online merchants is provided. The system may provide tools for individuals with limited experience in the online marketing industry to create and publish customized and personalized display advertising for these products and distribute this display advertising and links to the products by multiple methods. These distribution methods may enable users of the system to take full advantage of recommendation based marketing as well as push products ads and links directly to user devices such as smart phones and mobile devices of potential customers. This allows individuals to participate in a plurality of affiliate marketing programs of multiple online merchants on a single platform. Further, the platform enables the secure distribution of digital content via its legacy rights management IP and software.

In one aspect, computer implemented method for providing Internet based vending is provided that includes the steps of providing an Internet Vending publisher tool that creates a web page that displays a plurality of products for purchase selected from a first web site associated with an affiliate merchant and at least one product selected from a second web site, the second web site associated with a publisher, wherein the publisher makes available digital content or a product on the second web site for purchase, sending a first link to a device associated with a customer of the publisher wherein the first link is configured to link to a web page, the web page configured with at least one second link to a products or a service of the first web site and the web page further configured with at least one third link to a product or a service associated with the second web site receiving a product purchase selection from the device and facilitating a product purchase at the first web site or the second web site based upon the product purchase selection, wherein the product purchase at the first web site is facilitated by a unique identifier of the publisher associated with the at least one second link, wherein the providing, the sending, the receiving and the facilitating step are performed by a computer. The device may be a cell phone, a tablet computer, an electronic device or a personal computer. The first link may be sent using a short message service (SMS) message.

The Internet Publishing tool may create the web page that further displays a plurality of products for purchase selected from a third web site associated with a second affiliate merchant. The computer implemented method may further include the step of forwarding the first link from the device to a second device, wherein the second device is configured to permit a user of the second device to select the first link to access the web page to purchase a product at the first web site or the second web site. The at least one second link may be a plurality of second links, each of the plurality of second links linking to a separate product or service for purchase. The least one third link may be a plurality of third links, each of the plurality of third links linking to a separate product or service for purchase. The computer implemented method may further include the steps of receiving a request to share the web page on a social media web site and initiating sharing of the web page on a social media web site so that other individuals may access any of the products or services. The method may further include receiving a request to share the first link with a second device using a telephone number and initiating sharing of the first link to the second device. Access to the link, product or service may be controlled by a digital rights management technique so that access to the link, product or service is selectively granted or denied until an authentication of the accessing device or user is completed. The method may further include the step of aggregating and reporting amounts for purchases made at the first web site and for purchases made at the second web site so that sales totals and other financial statistics are shown on a common report.

In one aspect, a system for providing Internet based vending may include an Internet Vending publisher tool configured to create a web page that displays a plurality of products for purchase selected from a first web site associated with an affiliate merchant and at least one product selected from a second web site, the second web site associated with a publisher, wherein the publisher makes available digital content or a product on the second web site for purchase, a component executable by a computer and embodied in a non-transitory medium to send a first link to a device associated with a customer of the publisher wherein the first link is configured to link to a web page, the web page configured with at least one second link to products or services of the first web site and the web page further configured with at least one third link to products associated with the second web site and a component executable by a computer and embodied in a non-transitory medium to facilitate a product purchase at the first web site or the second web site based upon a product purchase selection wherein the product purchase at the first web site is facilitated by unique identifier of the publisher associated with the at least one second link. The Internet Publishing tool may create the web page that further displays a plurality of products for purchase selected from a third web site associated with a second affiliate merchant, wherein each affiliate merchant has separate requirements for being a affiliate. The system may further include a component to forward the first link from the device to a second device, wherein the second device is configured to permit a user of the second device to select the first link to access the web page to purchase a product at the first web site or the second web site. The product may be digital content and the digital content may be configured to control access of the digital content by a digital rights management technique at the device that prevents access to the digital content until authorization has been received. The system may further include a component to receive a request to share the web page on a social media web site and a component to initiate sharing of the web page on a social media web site so that other individuals may access any of the products or services. The system may further include a component to receiving a request to share the first link with a second device using a telephone number and a component to initiate sharing of the first link to the second device.

In one aspect, a computer implemented method for providing Internet based vending is provided. The method may include the steps of receiving at a portable device a message having a link to a web page, activating the link and receiving a common display of a plurality of icons representing products or services, each icon associated with a separate link to a product or service, wherein a subset of the separate links link to a first website and a second subset of the separate links link to a second website and a third subset of the separate links link to a third web site, wherein the second web site is a first affiliate web site and the third web site is a second affiliate web site, wherein the receiving step, the activating step and the receiving step are performed by a computer. The computer implemented method may further include the step of accounting for sales for purchases at each web site and reporting totals and other statistics in a common report for transactions at each web site. The computer implemented method may further include sharing the link with another portable device so that the another portable device may access the web page. The computer implemented method may further include sharing the web page on a social media site so that other users may purchase products or services from each of the web sites.

### BRIEF DESCRIPTION OF THE DRAWINGS

The accompanying drawings, which are included to provide a further understanding of the disclosure, are incorporated in and constitute a part of this specification, illustrate aspects of the disclosure. No attempt is made to show structural details in more detail than may be necessary for a fundamental understanding of the disclosure and the various ways in which it may be practiced. In the drawings:

FIG. 1 is an illustration of an Internet Vending Machine (IVM) interface, configured according to principles of the disclosure;

FIG. 2 shows another version of an IVM interface displayed on an exemplary electronic device, configured according to principles of the disclosure;

FIG. 3 illustrates functional aspects of a Vendto Gallery provided by an IVM system, according to principles of the disclosure;

FIG. 4 is a flow diagram of steps of performing steps of a publishing process, the steps performed according to principles of the disclosure;

FIG. 5 is an exemplary display in table format showing a list of IVMs and related data that may be presented to the publisher, configured according to principles of the disclosure;

FIG. 6 is an example of an IVM dashboard page to display statistics that a publisher may use to analyze the performance of any IVM and its associated products, configured according to principles of the disclosure;

FIG. 7 is a block diagram of an example system, configured according to principles of the disclosure;

FIG. 8 is a flow diagram for performing an exemplary process, the steps performed according to principles of the disclosure; and

FIG. 9 is a flow diagram for performing an exemplary process, the steps performed according to principles of the disclosure.

### DESCRIPTION OF THE INVENTION

The disclosure and the various features and advantageous details thereof are explained more fully with reference to the non-limiting examples that are described and/or illustrated in the accompanying drawings and detailed in the following description. It should be noted that the features illustrated in the drawings are not necessarily drawn to scale, and features of one example may be employed with other examples as the skilled artisan would recognize, even if not explicitly stated herein. Descriptions of well-known components and processing techniques may be omitted so as to not unnecessarily obscure the principles of the disclosure. The examples used herein are intended merely to facilitate an understanding of ways in which the disclosure may be practiced and to further enable those of skill in the art to practice the principles of the disclosure. Accordingly, the examples herein should not be construed as limiting the scope of the disclosure. Moreover, it is noted that like reference numerals represent similar parts throughout the several views of the drawings.

A “computer”, as used in this disclosure, means any machine, device, circuit, component, or module, or any system of machines, devices, circuits, components, modules, or the like, which are capable of manipulating data according to one or more instructions, such as, for example, without limitation, a processor, a microprocessor, a central processing unit, a general purpose computer, a super computer, a personal computer, a laptop computer, a palmtop computer, a notebook computer, a desktop computer, a workstation computer, a server, or the like, or an array of processors, microprocessors, central processing units, general purpose computers, super computers, personal computers, laptop computers, palmtop computers, notebook computers, desktop computers, workstation computers, servers, or the like. Further, the computer may include an electronic device configured to communicate over a communication link. The electronic device may include a computing device, for example, but is not limited to, a mobile telephone, a personal data assistant (PDA), a mobile computer, a stationary computer, a smart phone, mobile station, user equipment, or the like.

A “server”, as used in this disclosure, means any combination of software and/or hardware, including at least one application and/or at least one computer to perform services for connected clients as part of a client-server architecture. The at least one server application may include, but is not limited to, for example, an application program that can accept connections to service requests from clients by sending back responses to the clients. The server may be configured to run the at least one application, often under heavy workloads, unattended, for extended periods of time with minimal human direction. The server may include a plurality of computers configured, with the at least one application being divided among the computers depending upon the workload. For example, under light loading, the at least one application can run on a single computer. However, under heavy loading, multiple computers may be required to run the at least one application. The server, or any if its computers, may also be used as a workstation. The server may host a website such as the Vendto website described herein.

A “database”, as used in this disclosure, means any combination of software and/or hardware, including at least one application and/or at least one computer. The database may include a structured collection of records or data organized according to a database model, such as, for example, but not limited to at least one of a relational model, a hierarchical model, a network model or the like. The database may include a database management system application (DBMS) as is known in the art. The at least one application may include, but is not limited to, for example, an application program that can accept connections to service requests from clients by sending back responses to the clients. The database may be configured to run the at least one application, often under heavy workloads, unattended, for extended periods of time with minimal human direction.

A “network,” as used in this disclosure, means an arrangement of two or more communication links. A network may include, for example, the Internet, a local area network (LAN), a wide area network (WAN), a metropolitan area network (MAN), a personal area network (PAN), a campus area network, a corporate area network, a global area network (GAN), a broadband area network (BAN), any combination of the foregoing, or the like. The network may be configured to communicate data via a wireless and/or a wired communication medium. The network may include any one or more of the following topologies, including, for example, a point-to-point topology, a bus topology, a linear bus topology, a distributed bus topology, a star topology, an extended star topology, a distributed star topology, a ring topology, a mesh topology, a tree topology, or the like. Online refers to and includes activity on a network by connected users of the network.

A “communication link”, as used in this disclosure, means a wired and/or wireless medium that conveys data or information between at least two points. The wired or wireless medium may include, for example, a metallic conductor link, a radio frequency (RF) communication link, an Infrared (IR) communication link, an optical communication link, or the like, without limitation. The RF communication link may include, for example, WiFi, WiMAX, IEEE 802.11, DECT, 0G, 1G, 2G, 3G or 4G cellular standards, Bluetooth, or the like.

The terms “including”, “comprising” and variations thereof, as used in this disclosure, mean “including, but not limited to”, unless expressly specified otherwise.

The terms “a”, “an”, and “the”, as used in this disclosure, means “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

A “computer-readable medium”, as used in this disclosure, means any medium that participates in providing data (for example, instructions) which may be read by a computer. The computer-readable medium may be non-transitory. Such a medium may take many forms, including non-volatile media, volatile media, and transmission media. Non-volatile media may include, for example, optical or magnetic disks and other persistent memory. Volatile media may include dynamic random access memory (DRAM). Transmission media may include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a computer. For example, sequences of instruction (i) may be delivered from a RAM to a processor, (ii) may be carried over a wireless transmission medium, and/or (iii) may be formatted according to numerous formats, standards or protocols, including, for example, WiFi, WiMAX, IEEE 802.11, DECT, 0G, 1G, 2G, 3G or 4G cellular standards, Bluetooth, or the like.

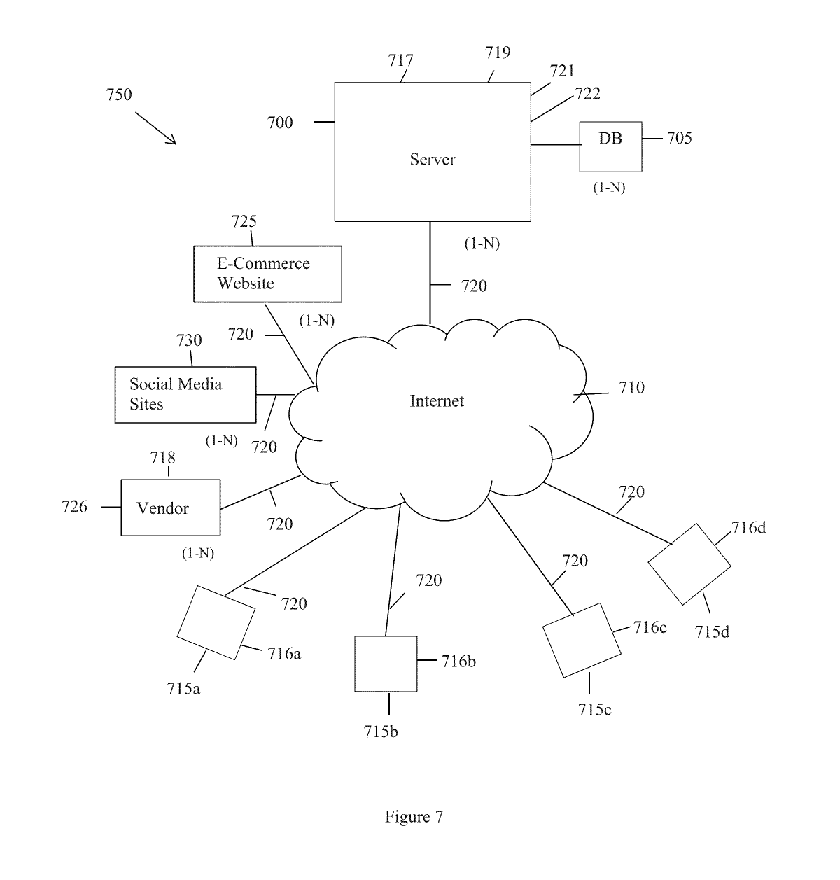

The Vendto Internet Vending Machine (IVM) or Mobile Vending Machine (MVM) of this present disclosure provides a method and system for individuals with little or no knowledge of the ecommerce industry and limited computer skills to act as an affiliate marketer or a marketer of self-promoted products, and/or a direct seller of goods and services via mobile and social channels. The IVM may be implemented on a computer system, server, and/or a network in operable communication with user computing devices. An illustrative example of a system for deploying IVM is shown in FIG. 7. The software for performing the steps and controlling the IVM operations (including input and output) of the disclosure may be implemented on computer platform and/or a computer readable medium which may be read and executed by a computer.

With the IVM, individuals may quickly and easily become affiliate marketers for online product distributors without being a member of any particular affiliate program. The IVM program also allows individuals to promote and sell products from multiple affiliate programs on one sales platform. IVM publishers are not limited to affiliate related products. A method is also provided for IVM publishers to market products outside the affiliate programs, including their own digital and physical goods.

The IVM provides marketers to way to quickly and easily display and sell nearly any number and mix of products. The IVM may be configured with a custom visual design as well as personal comments or recommendations. Customized audio or video promotions may also be added to the IVM that allows the marketer to differentiate the product presentation in the marketplace. The IVM publisher software also enables the creation of a personalized store environment where a large collection of products for sale can be accessed. The IVM in mobile and social channel use serves as both a promotion for and linking program back to this larger collection. Users can personalize the store with videos, photographs, blog posts, and podcast to both enhance the potential for sales and to enforce their social presence.

The Vendto program may also provide a centralized set of tools for the marketer to promote the IVM. Cut and paste code for embedding the IVM display into a web page is automatically generated for easy access. A custom HTML email template is also automatically generated for distribution by email. The promotion tools also include a method of automatically inserting the IVM display into social networks such as Facebook and public information feeds such as Twitter.

A method of quickly pushing the IVM link to the electronic device, such as a smart phone, of individual customers is also provided. This allows affiliate marketers to take advantage of one-to-one marketing opportunities or chance meetings with potential customers. Upon learning that a potential customer may be interested in a particular product, a customized IVM can be quickly created and pushed to the customer's smart phone.

The IVM program may also provide a smart phone app to deliver advanced features such as a coupon distribution and redemption program and secure digital content distribution. This secure coupon distribution methodology insures that a coupon can only be used once, except in the case where the issuer is fine with unlimited copies. The smart phone app may introduce a custom GPS geolocation feature so that customers are alerted by their phone to IVMs that have been placed in a particular location.

When customers purchase a product through the IVM, the merchant may place the commission for the sale into the Vendto master commission account for that affiliate program. At the end of the accounting period, the Vendto commission program then credits the commissions from the various affiliate programs into the individual commission account for the Vendto member affiliate marketer. It is in this manner, that the Vendto affiliate marketer can participate in various affiliate programs without actually having to be a member of those programs.

Tracking and analytical tools are also provided to the publisher of the IVM. These tools record and display use measurements from the IVM such as page views, product click-throughs and purchase data. This data is conveniently displayed for analysis by the IVM publisher on his secure account section of the Vendto.com website.

In one version, the Internet Vending Machine may be a web page that is published as part of the “Vendto.com” web structure. The IVM is created by a Vendto publisher by stepping through a creation wizard on the Vendto.com website. A Vendto publisher is an individual or entity who has created a member account on the Vendto.com website.

The IVM may display images and information about products that have been added to the IVM by the publisher. URL links embedded in the images or copy displayed on this page let customers access the merchant website for the product listed to get more information about or purchase the product.

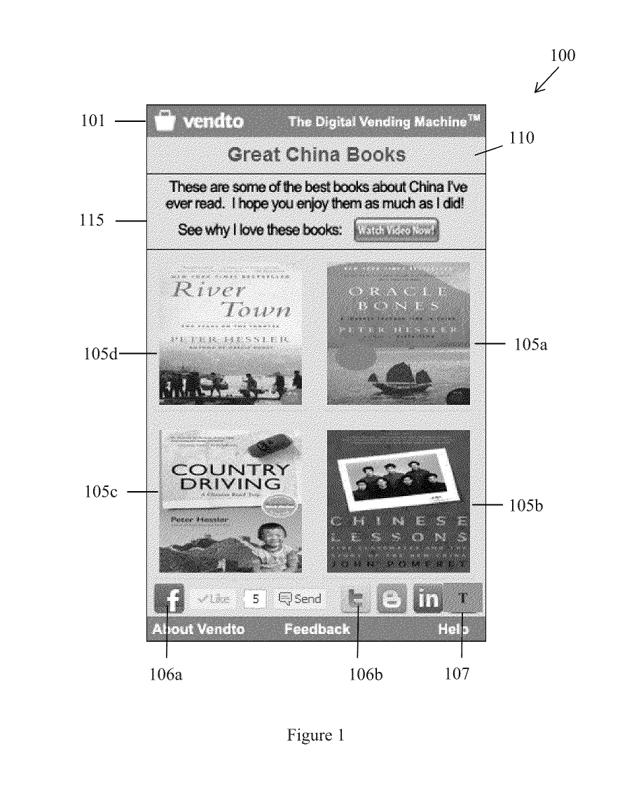

FIG. 1 is an illustration of an IVM interface 100, configured according to principles of the disclosure. This IVM interface may be displayed on a display of user's electronic device, such as, e.g., a mobile phone, a tablet computer, or the like. Below the Vendto-IVM branding bar 101 at the top of the display, the title 110 of a specific instance of an IVM interface 100 may displayed which in this example is related to Great China Books. Other instances of an IVM interface 100 may display any subject matter related to products or services. An optional comment area 115 may be displayed below the title 110 that allows the publisher to customize or personalize the IVM interface 100. This is particularly useful in the one-to-one marketing situation where the IVM interface 100 is pushed to a specific individual's electronic device. In that case, the comment may be something like, “Hi, Jim. These are the books I was telling you about.”

The publisher also has the option of adding a link to a promotional audio or video file in the comment area 115. This can be a custom file created by the publisher that adds a further personalized comment or recommendation or it can be a link to a commercially produced file that provides a guide to operation or installation of the one or more product(s) or service(s) being displayed.

The central area of the IVM interface 100 may displays images 105a-105d and/or copy (text) that is configured to link a potential customer to a merchant website for the particular product to provide a purchase opportunity, when the link is selected/activated by a user. As shown in FIG. 1, the linked images 105a-105d for the respective products in this IVM interface 100 may be configured or arranged in a grid style format, but other formats are contemplated. There may be more or less display images 105a-105d and/or copy different from that shown in FIG. 1 for any specific IVM interface. The display images 105a-105d may be ICONS.

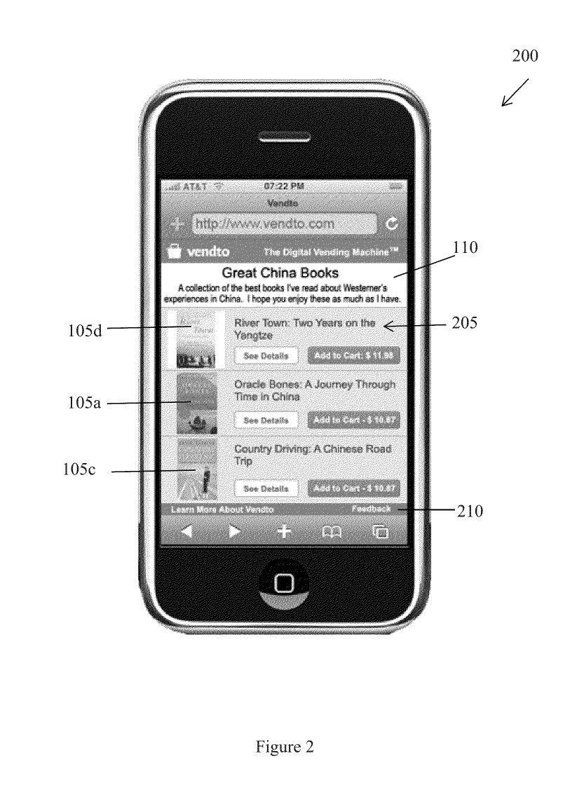

FIG. 2 shows another version of an IVM interface 205 displayed on an exemplary electronic device which, in this example, is a smartphone 200, configured according to principles of the disclosure. In this example, the product images 105a, 105c and 105d (configured with links) and copy are arranged in a vertical scrolling format. A variety of presentation formats are available for IVM publishers. FIG. 2 also demonstrates that the IVM display is customized mainly for viewing on smart phones. The IVM interface 205 page can be programmed to detect the screen resolution of the user's device and present a version of the IVM interface 205 that is best suited to that resolution. The device of FIG. 2 could also display the IVM interface 100 as shown in FIG. 1, as warranted.

As shown in FIG. 1, links to various social networks 106a, 106b, blogs and information sharing websites may be located or associate with the product images 105a, 105c and 105d. This makes sharing of the IVM links quick and easy for customers and enhances the viral marketing aspect of the IVM. Also, a link 107 (a “text” link) permits a user to share a website or the IVM interface 100 (such as shown in FIG. 1) with another device such as a mobile device. The sharing may be performed by using a telephone number to send to another mobile device so that another user can see the same web site or IVM interface to make purchase if they so desire.

The bottom branding bar 210 of the IVM interface 205 may display links that let viewers get more information about the Vendto program, post feedback messages about IVM and get help and support for the product. The feedback function is particularly important as it gives the IVM publisher immediate input from customers permitting timely editing of the IVM interface presentation or changing the product mix in a way that may improve the sales performance of the IVM.

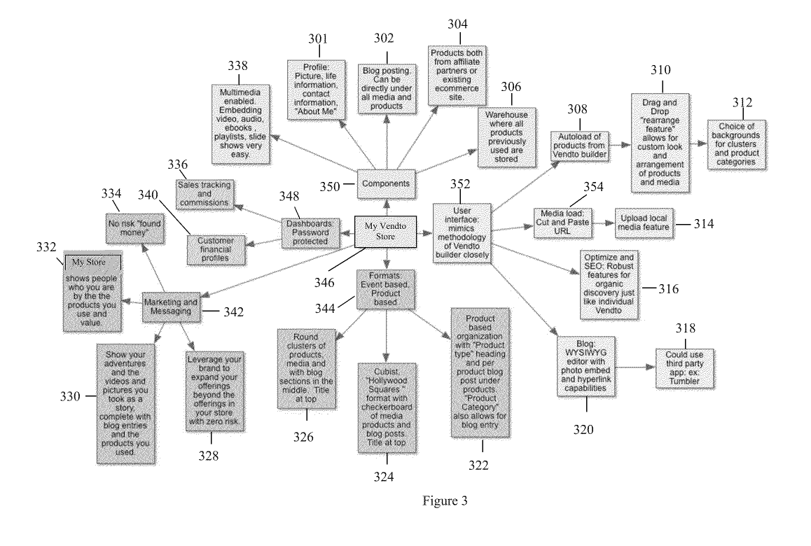

FIG. 3 illustrates the functional aspects of a Vendto Store 346 (also known as the web store) provided by an IVM system 750 for a particular subscriber, the functional aspects may comprises one of more of the following components, according to principles of the disclosure:
Web store—permits viewing of products in “Your Web store.” The Web store (346) becomes focus of a user profile where the “personality” of the subscribing user is on display with their chosen products. A picture, information about their likes, expertise or point of view. A daily mini-blog update piece and the ability to organize the products according to categories. The URL for the store becomes yet another piece of identifying and vanity information that can be posted on, e.g., social sites (e.g., Facebook™, Twitter™, and similar social media web sites) including business sites such as Linked In™. Link to the store travels with every Vendto and serves as a central hosting site for the publisher's customers. Components (350)
A. Multimedia enabled (338). Embedding video, audio, ebooks, playlists, slide shows very easy.
   Media may also include Google Earth (GE) Snapshots and other relevant location based data. Using geo targeting in combo with GE could show Vendto geo sites around the world.
B. Profile (301): Picture, life information, contact information, “About Me”
C. Blog posting (302). Can be directly under all media and product.s Blog may be full featured and allow linking to other sites, full featured text editing and photo embedding.
D. Products both from affiliate partners or existing ecommerce site. (304) Product search based on individual user preferences preset at registration. Vendto provided API lets current ecommerce configurations from customers be searched with preference.
E. Warehouse (306) where all products previously used are stored.
   Three buttons may be configured: View, Recommend, Delete
Formats (344): Event based, Product based
A. Round clusters of products, media and with blog sections in the middle.
   Title at top, designated by reference numeral (326).
   Comment and share capabilities under each product
B. Cubist, “Hollywood Squares” format with checkerboard of media products and blog posts. Title may be at the top, designated by reference numeral (324).
C. Product based organization with “Product type” heading and per product blog post under products. “Product Category” also allows for blog entry, designated by reference numeral (322).
   Can be URL based such that link takes to one page if needed.
User interface (352): mimics methodology of Vendto builder closely
A. Autoload of products from Vendto builder (308)
   1. Drag and Drop “rearrange feature” allows for custom look and arrangement of products and media (310)
      Choice of backgrounds for clusters and product categories (312)
B. Media load: Cut and Paste URL (354)
   1. Upload local media feature (314)
C. Optimize and SEO: Robust features for organic discovery just like individual Vendto (316)
D. Blog: WYSIWYG editor with photo embed and hyperlink capabilities (320)
   1. Could use third party app: ex: Tumbler (318)
Dashboards: Password protected (348)
A. Sales tracking and commissions (336)
B. Customer financial profiles (340)
Marketing and Messaging (342)
A. My Store shows people who you are by the products you use and value (332).
   Examples:
   1. A teenage girl searches for and posts all of the clothes, shoes and anything else she likes both to show her idea of herself but also as a wish list. She sends the link to her extended family.
   2. A guy that really likes fishing and knows a lot about it posts his favorite stories, locations he has fished (via Google Earth) and his most trusted products he uses.
   3. A business expert posts all of the books and resources he uses and his appearance schedule (allowing reservations to be made). He synchronizes this with his professional blog.
   4. A builder shows video and pictures of his latest projects and features some of his favorite building materials, lighting, and other details.
B. Show your adventures and the videos and pictures you took as a story, complete with blog entries and the products you used (330).
   Examples:
   1. Pro surfer shows latest surf trip complete with videos and all the products he used during the trip.
   2. Family takes trip and displays videos, pictures and stories of the trip, including the products that make the trip nice including the hotels, the airlines, the tour group, the rental cars, etc.
   3. A fashion maven takes a trip to NYC and features all the great clothing and shoes she saw while there.
   4. A product company shows the story of the product including videos of it in use, and how to use, then provides the products for sale along with complementary products.
   5. Movie studio delivers interviews, products and even ticket buying capabilities to social media. Create mini Fan sites.
C. Leverage your brand to expand your offerings beyond the offerings in your store with zero risk (328).
   Examples:
   1. A fish and tackle store with a great brand leverages their brand to sell everything related to fishing including boat motors, electronics, fishing trips and great hotels at fishing destinations, extending the brand in a no risk way for more complete service and commissions.
   2. A non-profit environmental group that protects a river system serves the needs of boaters, kayakers, fishermen and swimmers sells products that are used on the river and the profits go to the charity.
   3. A famous radio DJ designs her syndicated radio show around merchandising via Vendto. Each shows music playlist, books, products from interviewees, recommended fashion and anything relevant to the show posted along with a podcast of the last weeks show.
   4. A politician releases regular videos with new message and fun raising inside each Vendto.
D. No risk “found money” (334)
   1. I know a lot about this one thing and its fun stuff. What do I have to lose by putting in in a store and telling people all I know about it. It's fun and if I sell something I make a little found money, with no risk.

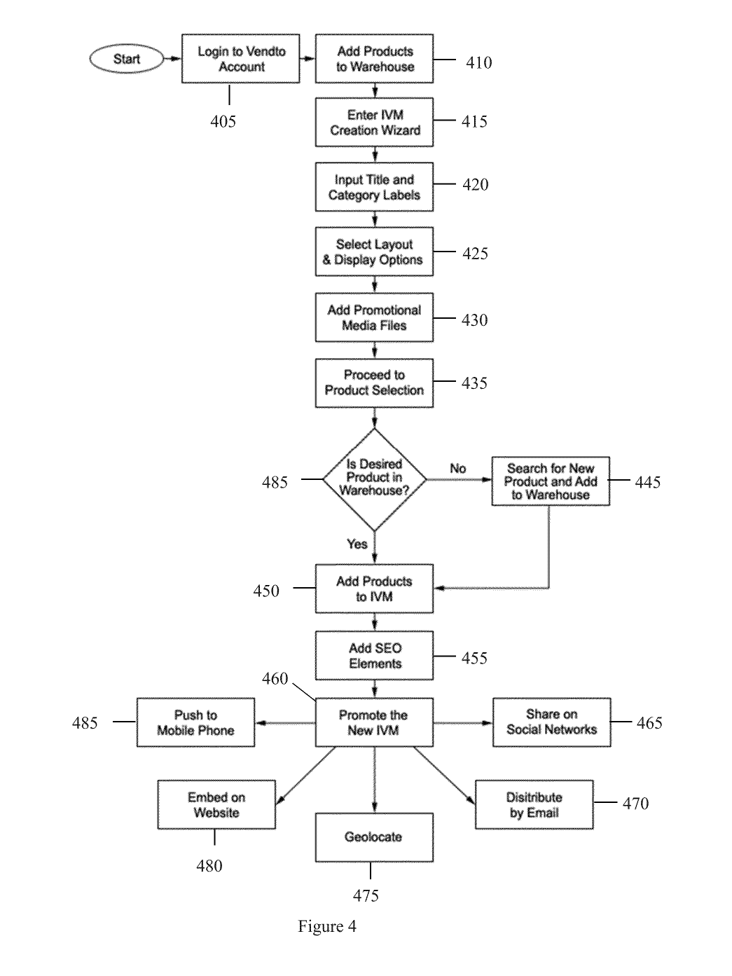

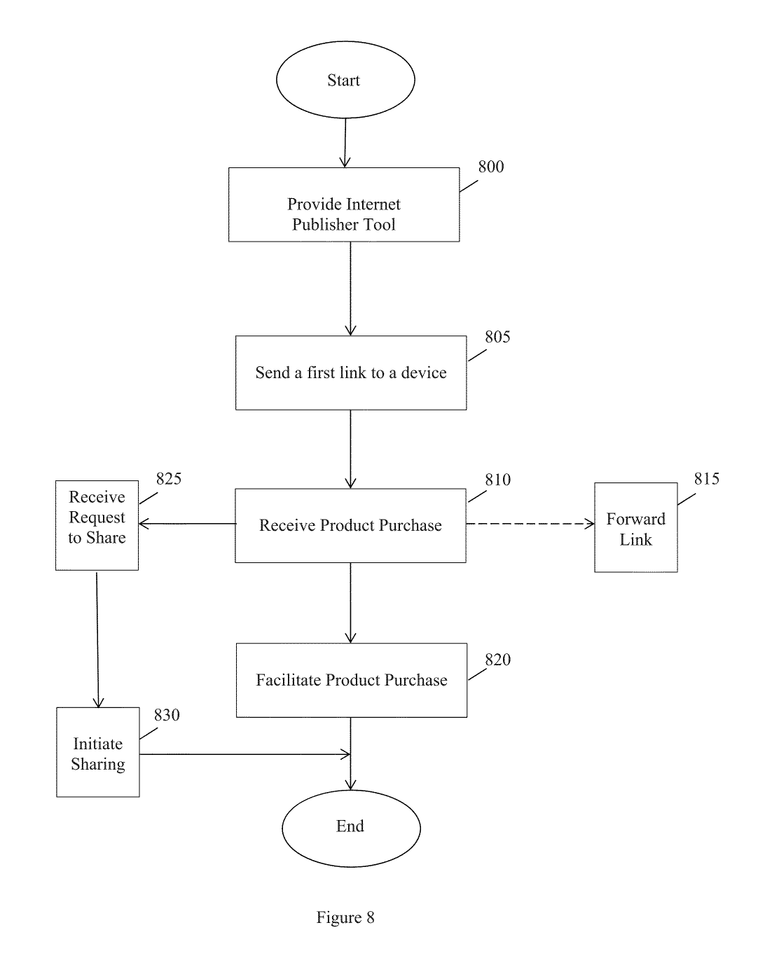

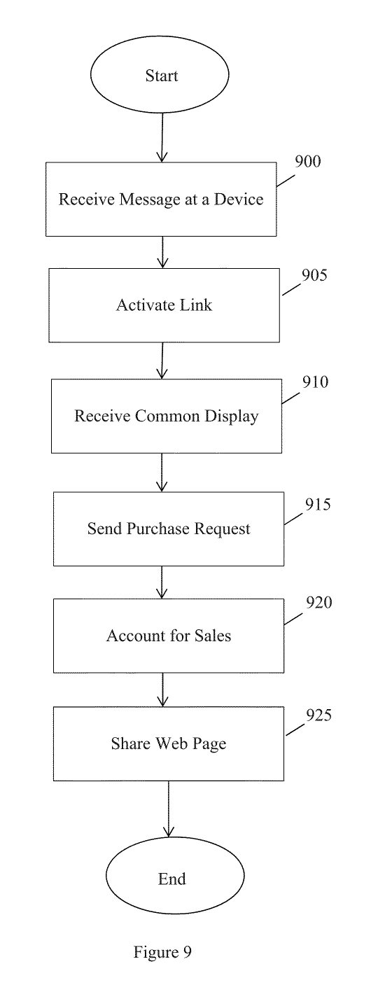

FIG. 4 is a flow diagram of steps of performing steps of a publishing process, the steps performed according to principles of the disclosure. FIG. 4 (and all other flow diagrams herein including flow diagrams of FIGS. 8 and 9) may also be a block diagram of components of a system in combination with computer processing hardware configured to execute the steps thereof. FIG. 4 (and any other flow diagrams herein) may also reflect the software logic of a computer program product embedded on a computer readable medium that when read and executed by a computer performs the described steps. The process of FIG. 4 may be performed by the system of, e.g., FIG. 7. The flow diagrams herein may also represent components of a computer program product that is store on a non-transitory storage medium, the components configured so that when read and executed by a processor, perform the respective steps of the processes of the flow diagrams.

At step 405, the IVM process typically begins with an individual logging into the Vendto.com website and opening a publisher account. When the publisher's Vendto account is created, the account is assigned a unique account code (or other identifier) that is linked to all transaction and accounting functions of the publisher. Upon receiving verification of the account the individual can login to the created Vendto account and begin publishing IVM interfaces 100. At step 410, the publisher may populate the Product Warehouse section of the Vendto account with products. This is done by using a search tool provided in the Product Warehouse. This tool may use an application programming interfaces (APIs) provided by various merchant websites to give programmatic access to the merchant site's product selection and discovery function. In this way, the publisher can enter search terms in the search tool and view the results directly in the Product Warehouse interface. Conversely, Vendto may provide an API to merchants who would like to make their product inventory available to IVM publishers for search and discovery in the Vendto system. A feature may be included in such an API that allows merchants to bias this Vendto product search to make their products appear higher in the search results. This feature may be configured to be applicable to individual IVM publishers as defined by information made available in the publisher profile entered into the Vendto website or obtained from other sources.

A significant function of the Vendto product search software is to insert the publisher's unique account code (or other unique identifier) into the product link that is now associated with the products returned by the search results. An example of this link modification is shown below.
A none product link returned in the affiliate merchants search results:
http://www.amazon.com/s/ref=nb_sb_ness?url=search-allies%3Dpopular&field-keywerds=Hot%20Rocks%201964-1971%20%5BOriginal%20Recording%20Remastered%5D
A modified product returned in the Vendto search results:
http://www/amazon.com/Hot-Rocks-1964-1971-Rolling-Stones/dp/B00006EXDM!SubscriptionId=AKIAIT6FZQ6A34IQMAQQ&tag=vendto0d69-20&linkCode=sp1&camp=2025&creative=165953&creativeASIN=B00006EXDM

The transaction and accounting software of all affiliate merchants that the Vendto website links to through their search and reporting APIs are programmed to recognize and accept this account code (or other unique identifier) and store it in a manner that links it to the transactions in question. Periodically, the Vendto accounting software may request transaction and accounting data through the affiliate merchant's reporting API. Any transactions that are reported back to Vendto upon this request include this unique account code (or other unique identifier). In this manner, the Vendto accounting software can keep track of which publisher account should be credited for the transaction and properly assign any resultant commissions.

When the publisher adds a product from the search results to his Product Warehouse, the publisher may be prompted to enter a custom product name and description that may be displayed in the IVM interface 1100. The publisher may also be prompted to enter optional category and sub-category labels for the product. These labels may be used by the publisher to sort and display various subsets of products in the Products Warehouse during the IVM interface 100 creation process. This can be very useful when the Product Warehouse becomes populated with large numbers of products.

The Product Warehouse interface may also provide the publisher with a method of loading products not associated with affiliate marketing merchants. This can include digital and physical goods created by or originating with the publisher. In this case all functions related to the discovery, purchase and fulfillment of the product by the IVM customer may be handled by the Vendto.com backend.

At step 415, once the Product Warehouse is populated, the publisher can begin creating one or more IVM interfaces 100. At step 420, a title and optional custom category and sub-category labels may be entered for the new IVM interface 100. These labels gives the publisher great flexibility when sorting and viewing a large pool of IVMs in the main listing table displayed on the home page of a subscriber's Vendto account.

At step 425, the layout type and design details of the new IVM interface 100 may be selected. Image and copy layout arrangement options for one or more products may include the grid and vertical scroll types shown in FIGS. 1 and 2, as well as horizontal scroll and other types. Design detail options may include font type and color, background color, and outline color. To save time, the publisher may elect to choose from a menu of preloaded professionally designed layouts. Design tools may be provided to customize each of these design elements if desired. The publisher may choose to save a custom design and add it to the list of preloaded layouts for future use. The IVM wizard 722 (which may be hosted at server 700) may provide a preview display of the new IVM to give the publisher a look at his layout and design choices in real-time.

At optional step 430, promotional media files may be added to the new IVM interface 100. The wizard interface may allow the publisher to upload a file or content such as, e.g., an audio or video file from his local computer to be mounted on the Vendto.com backend or enter the URL of a file published in another location. The publisher may also enter a custom comment about the media file such as the “See why I love these books” phrase displayed in FIG. 1. An appropriately labeled Play button may be automatically added when the choice of adding an audio or video file is made by the publisher. The design of the new IVM may be saved.

At step 435, the publisher may proceed to the Add Products step of the wizard. The wizard interface may display a list of products previously loaded into the publisher's Product Warehouse. This list may be sorted by a number of factors that can include product name, affiliate merchant, category, sub-category, date added and price.

At step 440, a check may be made to determine if a desired product is in the Warehouse. If not, at step 445, a search for a new product may be performed so that the product may be added to the Warehouse, with the process continuing next at step 450.

If, however, a desired product is in the Warehouse at step 440, then at step 450, the product may be added to the new IVM interface 100 by using, e.g., a drag-and-drop feature of the wizard interface to drag products from the listing table into the IVM interface 100 or preview display. By dragging and dropping products into and out of the preview display the publisher can experiment with and adjust the product mix and display arrangement to maximize the effectiveness of the new IVM interface 100.

At step 455, optional Search Engine Optimization (SEO) elements may be added to the new IVM interface 100. For example, SEO elements may be added to the HTML code of a webpage so that the page can be found, read, and indexed by search engines in the most effective manner possible. The wizard interface may allow the publisher to add SEO elements that can include meta title, meta description, meta keywords, meta author, and header titles. Another SEO related element that may be added is an URL alias. When the new IVM is published, the Vendto.com website may automatically generate a URL for the IVM interface 100 display page. The URL address that is automatically generated may include obscure character strings that are not search engine friendly. The URL alias feature may allow the publisher to input a custom URL address that is presented to search engines and makes it more likely that the search engines will rank the page higher in their search results.

Since many publishers may not understand SEO or find it tedious to input custom SEO elements, the wizard may include a feature that automatically generates the SEO elements. This feature may employ proprietary code on the Vendto website 719 that generates the SEO elements from product information such as the product name or descriptive copy obtained from the merchant website during product search through the merchant API or input by the publisher when the product is added to the Product Warehouse.

The SEO elements are needed only when the publisher is interested in maximizing the ranking of the IVM page in search engine results. In some situations, such as when the publisher wants to quickly create an IVM and push it to an individual's smart phone, search page rankings are not important and the SEO step can be skipped completely.

The new IVM is now complete and may be automatically published by the creation wizard. At step 460, the publisher may proceed with the promotion stage of the wizard which presents an aggregation of link and ad distribution tools that enable the publisher to quickly and efficiently execute an IVM marketing campaign.

A mobile phone push tool 485 is configured to provide for the publisher to enter mobile phone numbers and automatically send a preformatted message to those mobile phone numbers which displays the link to the IVM interface 100. When the recipient presses a link associated with an image 105a-105d (or associated with text) in the preformatted message, the phone's browser displays the IVM interface 100 such as, e.g., illustrated in FIG. 2.

A sharing tool 465 may also be provided that may include a collection of links that lead directly to the publisher's account in social and information distribution networks such as, e.g., Facebook™ and Twitter™. For example, when the publisher presses the Share on a Facebook™ button in the sharing tool interface, a browser window may be opened that automatically takes the user to the sharing tool for his Facebook™ wall. The title and other information about the IVM, along with Vendto logo and branding blurbs, may be automatically inserted into the ad. All the publisher has to do is input an optional custom comment and press the share button and the ad, which displays a link to the IVM, is placed on his wall and shared with all of his friends.

The Share on Twitter™ tool may work in a similar way. It also opens a browser window that automatically takes the publisher to the Tweet origination interface of his Twitter™ account. As with the Facebook tool, the link to the IVM along with some promotional copy is automatically inserted into the interface and the Tweet is ready to be sent. The sharing tools can also be used in a similar manner with various blog and RSS feed origination sites.

An IVM code embed tool may be included in the promotional tool interface. This tool displays html code that can be inserted into any web page by the cut and paste method. This code embeds the full functionality of the IVM into the edited web page so that a viewer can access a merchant website for a product directly from the IVM display on that page instead of merely being taken to the Vendto.com IVM address as with a standard ad or link.

This embed code can also include the mobile phone push tool 485. This allows any viewer of the embedded IVM display on any website to enter a mobile phone number and send a message containing a link to the IVM to that number. This feature enhances the viral distribution capability of the IVM embed tool.

Another promotion tool provided may be an HTML email distribution template 470. This tool displays HTML code that may be automatically generated by Vendto to display a custom ad for the IVM. This code is intended to be inserted into an HTML email editor by the cut and paste method. This ad displays promotional images and copy for the IVM that contain links to the IVM display page on the Vendto site. The tool interface also displays link buttons to various email marketing services such as iContact and Mailchimp which typically utilize HTML email editors.

The publisher uses this tool in a manner similar to the other sharing tools. After copying the HTML code from the email template window in the wizard interface, the publisher accesses his email marketing service account with the link buttons displayed in the interface or by other means and pastes the code into the HTML editor provided by the email service website. The publisher may then begin distributing the IVM HTML ad through the email marketing service.

An alternative method of promoting the IVM that is provided by the wizard is a geolocation feature 475. This technique is specifically designed for smart phones and other mobile devices and requires that a mobile app 716a-716d be downloaded, installed and running on the device in order for the system to operate.

To use the geolocation feature 475, the publisher may drag a symbol of the IVM onto a map displayed in the wizard interface. This map can be supplied by commonly used map services such as Google™ or MapQuest™. When the location is selected, a mapping software module on the Vendto website may reference a database containing commonly available GPS coordinate libraries and then generates and stores a GPS coordinate for the IVM location.

When a Vendto geolocation feature 465 is running on a mobile device, the app 716 (FIG. 7) may periodically contact the Vendto website and transmits the GPS coordinates of the device. Upon receiving this data, a coordinator software module 717 on the Vendto site may compare the coordinates with that of a database of stored IVM geolocation coordinates.

If the program determines that any of the stored IVM coordinates are within a predetermined distance of the location of the mobile device, e.g., 715a-715d, a message may be transmitted back to the mobile device that causes the Vendto mobile app 716 to alert the user via “push notification” that there is an IVM nearby. This alert displays a link to the IVM that allows the user to access the IVM display page in his mobile device browser.

The geolocation feature 475 can be used by the publisher in a variety of ways. For example, an IVM can be geolocated near a brick and mortar store that alerts nearby Vendto mobile app 716 users to the publisher's IVM which markets a similar product online at a better price. The GPS coordinates are usually precise enough so that the publisher may geolocate multiple IVMs inside a large big box retail store. In this example, the publisher can geolocate an IVM marketing appliances near, e.g., the appliance aisle as well as an IVM marketing baseball gloves near the sporting goods section.

Since the geolocation promotion concept can be employed in such a wide variety of situations, the Vendto geolocation feature 465 may include a feature called variable alert distance. This feature allows the publisher to assign different alert distances to different IVMs.

For example, in the brick and mortar example above, the publisher may want to assign an alert distance of one hundred yards so that any Vendto mobile app 716 user near the store may be alerted to the IVM. In the case of geolocating multiple IVMs inside the same large retail store, the publisher may want to assign an alert distance to those IVMs of fifty feet so that the Vendto mobile app 716 user may only be alerted to the IVM geolocated in that section of the store.

To enhance the ability of the IVM publisher to strategically plan the geolocation of future IVMs, the Vendto mobile app 716 may include a feature called geolocation grabbing. This feature allows the publisher to use the Vendto mobile app 716 to scout out locations where the publisher may like to geolocate a new IVM.

In the example of the large retail store, the publisher can go to the appliance section of the store with a mobile device 715 and press the Grab Location button on the Vendto mobile app interface. The app may record the GPS coordinates of that location and prompt the publisher to enter a custom name label for that location as well as additional notes.

The name for the location might be “Home Lumber on Church St.” and the notes may read “appliance section of store selling Kenmore™ and LG™ washers and driers—suggested alert distance of fifty feet.” The publisher can then press the Transmit button and the GPS coordinates of the location along with the associated label and notes are transmitted to the his account on the Vendto website.

When the publisher logs into his account and creates a new IVM, the geolocation display of the promotion stage of the wizard may list all of the grabbed location coordinates that have been sent in from the field. The publisher can then use the notes associates with the coordinates to construct a custom tailored IVM to place at that location.

Another feature offered by the IVM system 750 which can operate in conjunction with the Vendto mobile app 716 is a coupon distribution and redemption system. In this version, an IVM can be configured to deliver coupons that offer discounts or special promotions on products offered in certain other IVMs or in brick and mortar stores. This version may require that an IVM publisher wishing to distribute coupons enable this feature through his Vendto account administration interface. It may also require that the vendor wishing to redeem IVM coupons download and install a client or mobile app 716 in order to redeem coupons in point-of-sale systems or from mobile devices 715.

When the coupon distribution feature is enabled, the publisher can add coupons to his Product Warehouse 306 through a coupon creation wizard. This wizard may prompt the publisher to enter information such as vendor name, offer name, store ID, product name, coupon value and a redemption code. When the new coupon is added to the Product Warehouse 306, this data is stored in the coupon database on the Vendto website. The publisher can then add coupons to an IVM in the same manner that products are added.

Online coupon redemption can function for transactions executed on the Vendto backend or on affiliate merchant backends that have installed the Vendto coupon redemption code module. In one method of coupon redemption, the redemption code displayed on the IVM coupon is entered manually by the customer into the appropriate text input box during the sales transaction. If the customer is using the Vendto mobile app 716 to execute the transaction, the redemption code may be automatically transmitted to the backend along with other optional unique ID data generated by the Vendto mobile app 716. This ID data can be generated from data gathered from the device such as mobile phone number, chipset serial numbers, operating system serial numbers or other data unique to the device.

Upon receipt of the redemption code and optional ID data, the backend coupon redemption code transmits this data along with merchant and customer account ID data to the Vendto coupon database module. This module scans the coupon database to determine whether the coupon redemption code has been redeemed previously for that particular customer account on that particular merchant backend. In this manner, multiple redemption of the coupon by the same customer during an online transaction is prevented.

Depending on the results of the database scan, an acceptance or rejection message is transmitted back to the merchant backend and the customer is notified of the results. Upon acceptance of the redemption code, the price of the product is adjusted by the amount of the discount offered by the coupon and the transaction can proceed.

IVM coupons may also be redeemed at brick-and-mortar store locations. If the vendor is not concerned with multiple redemptions, the coupon can be redeemed by simply presenting a print-out or mobile device display of the coupon to a clerk at the store.

The Vendto vendor client app 718 as well as the customer mobile app 716 may be required to limit coupon redemptions at brick-and-mortar stores. In this scenario, when the customer wants to redeem a coupon from an IVM accessed from his mobile device 715, he may press a Redeem Coupon button that is presented on the mobile app 716 display. This starts a proprietary program in the mobile app which reads special code included in the coupon URL. The program combines this code with unique customer and mobile device ID data to produce and display a unique redemption code by alphanumeric character string and/or bar code on his mobile app 716 interface.

This code can then be entered manually by a clerk on the point of sale device or scanned by a bar code reader. In one version, the sales person may also take a picture of the bar code display with his mobile device 715 which can be converted by the Vendto vendor mobile app 716 into the code. The Vendto vendor app 718 that may be running on the point of sale system at a physical location of a vendor 718, may transmit the code along with any other appropriate transaction and vendor data to the Vendto coupon database module. The coupon database is scanned in the manner described previously and the resultant acceptance or rejection message is returned to the point of sale system. In this manner, multiple coupon redemptions by a particular customer from a particular mobile device can be prevented.

The IVM coupon system adds another dimension to the geolocation feature. IVM publishers can geolocate coupon IVMs that alert customers to discounts on products sold at that location or to similar products sold by competitors at another location nearby or online.

Another IVM feature enabled by the use of the Vendto mobile app 716 is a distribution reward system that encourages individuals to send IVM links they have received on their mobile device to other people. To participate in this version, an individual must open an account on the Vendto website 719.

In this system, the Vendto mobile app 716 interfaces with the device's text messaging and/or email client to record the number of times an IVM link has been sent to other potential customers. This is accomplished by parsing the outgoing messages for unique Vendto URL character strings.

Periodically, the Vendto mobile app 716 may send these transmission records to the user's account on the Vendto website 719, hosted at e.g., server 700. These records may include the number of times that IVM links have been forwarded, the IVM IDs included in these links as well as the identity of the recipients.

This information allows the distribution reward program participant to be credited not only for the number of times links (e.g., links associated with images 105a-105d or copy) have been forwarded but also for purchases made through the delivered IVM link. Credit for link distribution and/or sales made through the distributed IVM link may take the form of “Vendto Points” that can be reclaimed for coupons for products sold by other IVM publishers or for cash to be deposited into the user's account.

The Vendto mobile app 716 also makes it possible to securely distribute document or media files through the IVM, at the request of a publisher. Digital rights management techniques may be implemented using one or more techniques described in one or more patents U.S. Pat. No. 7,673,059; U.S. Pat. No. 8,396,933; U.S. Pat. No. 8,578,464; U.S. Pat. No. 6,389,541; and U.S. Pat. No. 8,402,558, which are incorporated by reference herein, so that digital content such as documents or media files are accessible only by an authorized user/customer.

This secure distribution services are made available to IVM publishers as an optional service that they may be charged for on a per use, per client or periodic basis. When the publisher signs up for the service, a Secure File area may be created in his Product Warehouse 306.

One method available to the publisher for encrypting content files to be added to his Product Warehouse 306 is to use the proprietary encryption module of the Vendto client app to encrypt the file on his local device 715 and then upload the file to the Vendto website 719 for possible storage in database 705.

The publisher may be prompted to enter usage rules for a particle file during the encryption process. Decryption data that may include decryption keys may also be generated by the client app during the encryption process. This decryption and usage rule data may be uploaded to the Vendto website in the background when the encrypted file is uploaded to the Product Warehouse 306. The decryption and usage data is then stored in a secure database, e.g., 705 on the Vendto backend. In one version of the invention, the usage rules and one or more decryption keys can be stored on the client in an encrypted manner and decrypted and read by the client app upon receiving the token from the Vendto backend which grants or denies access to the protected content.

The publisher may also upload unencrypted content files to the Vendto website 719 and trigger the encryption process described previously to run automatically in the background on the Vendto backend. When the process is complete the encrypted content file is added to the Product Warehouse 306 and the decryption and usage data is added to the secure database 306.

Once the encrypted file is in the Product Warehouse 306, the publisher can enter a price for the file as well as promotional copy that may include an image that may be used to represent the file in the IVM. The file is then ready to be added to an IVM just like any other product and offered for sale.

Any customer wishing to purchase or otherwise gain access to the encrypted file must have the Vendto client or mobile app 716 running on his device 715. In one version, the customer may access and purchase the file just like any other IVM product. Upon completion of the purchase transaction or other process required by the publisher to gain access to the file, the encrypted file may be downloaded to the customer's device 715.

When the customer attempts to open the content file, access to the file may be granted or denied in a process such as described, e.g., in one or more patents U.S. Pat. No. 7,673,059; U.S. Pat. No. 8,396,933; U.S. Pat. No. 8,578,464; U.S. Pat. No. 6,389,541; and U.S. Pat. No. 8,402,558. In this process, data is gathered from the customer's device and sent to the Vendto backend. Proprietary software code on the backend combines this data with data related to the encrypted content file, which may include the previously stored decryption and usage data, and creates a permission token.

This encrypted permission token is then returned to the customer's device 715 and the Vendto mobile app 716 may decrypt and read it and uses the data to either grant or deny access to the content file. If access is granted, the Vendto mobile app 716 may decrypt the content file and the customer can open and use the file. The customer can repeatedly open the file until the usage rules delivered in the permission token and stored by the Vendto app prevent it.

The secure file distribution feature is not limited to offering secure content files for sale. In one version, a Secure Distribution section 721 of the promotion stage of the IVM creation wizard may be provided to the IVM publisher who signs up for the secure distribution service.

The interface of the Secure Distribution section 721 allows the publisher to create, edit and store lists of individuals who may be pre-approved to access the secure content files displayed in a particular IVM. This list may contain the mobile phone number or other type of address of the mobile device of the intended recipients.

The Secure Distribution interface may provide a tool that automatically sends preformatted text or email messages that may contain an IVM link to all of the members of any of the secure distribution lists. To finalize the formation of a secure distribution group, the publisher may use the group push tool to issue an invitation to join the secure distribution group to the addresses on the list.

When a member of the group receives the invitation, the link included in the message may guide him to a page on the Vendto website 719 that prompts him to download and install the Vendto client or mobile app 716 that includes the secure distribution code module if he has not already done so. He may then be prompted to confirm his membership in the group.

This confirmation process can be used to alert the secure IVM publisher that members of the group have or have not confirmed their membership by a certain date. In this manner, the publisher may be made aware that all of the members of the group have downloaded the appropriate version of the Vendto client or mobile app 716 and are ready to access secure content files through the IVM or that some members need to be reminded to do so.

The secure file distribution process may also provide a delivery confirmation feature that alerts the publisher that all or some members of the distribution group have accessed a secure content file displayed by an IVM that has been pushed to the group. This feature is enabled by the addition of a content file access confirmation message capability in Vendto client or mobile app 716.

This confirmation message may be created and transmitted by the Vendto client or mobile app 716 during the access granting process described previously. The app 716 may be programmed to generate and transmit this message by detecting that the permission token has been received from the Vento backend and that the secure content file has been successfully decrypted.

This IVM publisher may find this feature to be helpful in scenarios where is important that all or some members of a distribution group gain access to a secure content file by a particular time or date. The Secure Distribution interface may be configured to send an alert message to the IVM publisher confirming that all or some members of the distribution group have or have not gained access to the secure content file by the delivery deadline.

The Vendto program provides IVM publishers with a full array of data for tracking and analyzing the use of their IVMs. This data includes IVM page and product access measurements gathered by the Vendto backend as well as similar product page viewing and purchase data provided by the affiliate merchant backend delivered via the affiliate provided API.

Measurements collected by the Vendto website site 719 may include the IVM page load count, product item clicks, Data about the customer device is also gathered and may include the IP address, OS version, browser type and access timestamp. Data delivered by the affiliate merchant backend may include the product information page view count, the shopping cart view count and financial data such as purchase transaction amounts and dates and commission totals.

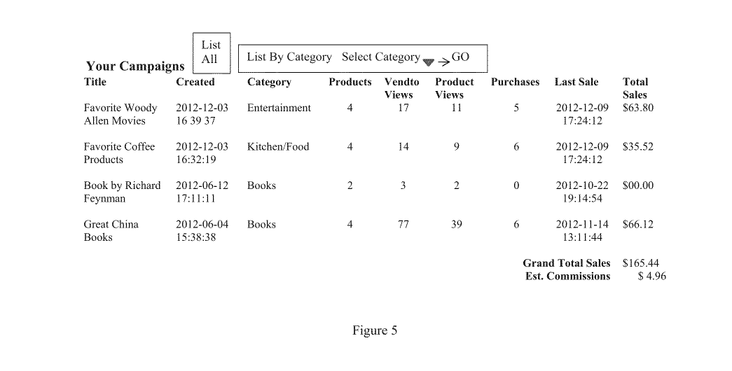

The Vendto backend stores this information and may present the data to the publisher in a tabular format in his account interface. Data that may be presented in such a table may include the IVM title, creation date, category, sub-category, IVM page view count, the number of products displayed in the IVM, individual products view count, product purchase count, date of last sale, total sales amount and commission total for the IVM. FIG. 5 is an exemplary display in table format showing a list of IVMs and related data that may be presented to the publisher, configured according to principles of the disclosure. FIG. 5 shows four different examples of IVMs for a particular subscriber to Vendto including “Favorite Woody Allen Movies,” “Favorite Coffee Products,” Books by Richard Feynman,” and “Great China Books.” For each IVM, a column showing date created of the IVM, a category of the IVM, number of products associated with the IVM, how many views have been made to the IVM, how many purchases for each IVM, a date of a last sale indication, and total sales for the particular IVM. Also, a grand total sales indicator and perhaps an estimate of commissions generated to date may be shown.

More detailed data about individual IVMs and their associated products may be displayed in a similar tabular format on a summary or dashboard display page. Data that may be presented on such a page may include products names, product price, product category and sub-category, the date that the product was added to the IVM, an individual product view count, an individual product purchase count, individual product purchase totals, click-through counts to the merchant product information and shopping cart pages as well as sales and commission totals for the individual products.

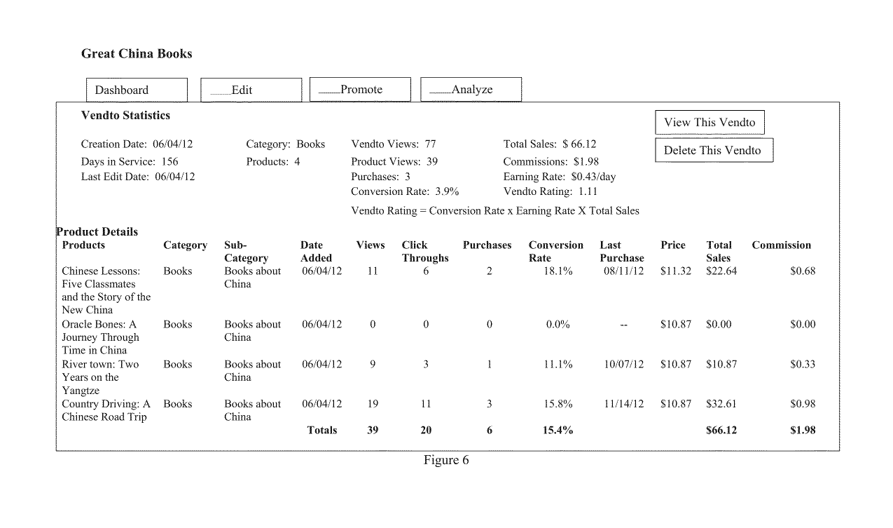

FIG. 6 is an example of an IVM dashboard page to display statistics that a publisher may use to analyze the performance of any IVM and its associated products, configured according to principles of the disclosure. The example in FIG. 6 shows data for the “Great China Books” IVM. As shown, this IVM includes four books as the IVM products including “Chinese Lessons: Five Classmates and the Story of China,” “Oracle Bones: A Journey Through Time in China,” River town: two Years on the Yangtze,” and “Country Driving: A Chinese Road Trip.” These statistics may be produced by performing calculations using the various IVM and product measurement data. One example of such a statistic may be the conversion rate which is a ratio of the number of times a product has been clicked on versus the number of times the product was actually purchased. Another example of such a statistic is the earning rate, which may be produced by dividing the total sales amount by the number of days in the product has been offered for sale. Statistics such as these can used by the publisher to analyze the performance of IVMs and individual products so that adjustments can be made to the presentation, products mix and promotion of the IVM. The

One of several purposes of the Vendto program is to produce commission revenues for IVM publishers as well as profits for the service provider (e.g., Vendto.com). A unique feature of the Vendto commission structure is that it may enable IVM publishers to collect commissions from multiple affiliate programs without actually being a member of any of the affiliate programs.

This may be accomplished by the use of a Vendto master account which is opened and maintained on each affiliate merchant website 725 that agrees to participate in the Vendto program. The affiliate may provide Vendto with a certain number of account IDs that are affiliated with the master account.

When a new IVM publisher account is created, the Vendto backend may automatically assign an account ID from each participating affiliate master account to the publisher's account. Every product that the publisher adds to his product warehouse from a particular affiliate program may be linked to the affiliate-provided account ID that has been assigned to his account.

When a product is purchased on the merchant website 725 through an IVM, the Vendto account ID for that publisher may be passed to the merchant site 725 and may be linked to the purchase in the merchant accounting database. The commissions earned from all products sold through any IVM on the merchant site are paid into the Vendto master account.

When the affiliate merchant settles the account and transmits the commission payment from the master account to Vendto, the merchant may also transmit the accounting data associated with the master account which may provide subtotals of the commissions linked to the IVM publisher's affiliate account ID. This data may then be used by the Vendto backend to credit the IVM publisher's commission account

Vendto website 719 or sever 700 may be configured to serve as a secure gateway to streamable movies, video, music and e-books, or the like. This method for controlling access to the digital content or products may include the steps of: maintaining on a listening server an open port which receives requests from local or remote programmatic interfaces to access a digital file. The listening server passes the request to a program which determines whether the interface making the request has permission to access a digital file based on a conditional access model. If the request is permissible, the listening server's response headers are generated based on the file type of the requested digital file. This allows the response to be interpreted by the requesting interface as if direct connection was made to the digital file, and thus the requesting interface can interpret, download, or stream the file using established protocols. If the request is denied, the access model returns a response that tells the requesting interface that the requested file does not exist. This allows the requesting interface to connect over established protocols without requiring method modification to handle the conditional access model.

This method is used in conjunction with hardware mounted computer code to enable this same media to be streamed directly to TV's and other displays via wifi. In this use a retailer like a grocery store sells a token or randomly generated code to a customer who then enters it into their smart phone, computer or TV to view digital content. This is beneficial to potential customers who do not have credit cards for online purchases including children. The code is the “key” to the secure conditional access process as described above and in other patents from the Company. The code is either printed at the point of purchase (POP) moment or delivered by test (SMS) to the customers smart phone. Prerecorded media can be included with the hardware and can be authorized in the same manner in individual “chunks” depending on the desires of the content owners.

FIG. 7 is a block diagram of an example system, configured according to principles of the disclosure. The system 700 is suitable for carrying out the processes of FIGS. 4, 8 and 9, and for managing the overall inputs and outputs associated with the Vendto web site including the example displays shown in FIGS. 1 and 2. The system 750 may include a server 700 having a processor and a memory connected to a database 705. The server 70 may be interconnected to a network 710, which may be the Internet, by way of communication link 720. The system 700 may include one or more user devices 715-715d, which may be a mobile electronic computing device such as a smart phone, the user devices 715a-715d may include a mobile phone app 716a-716d that may be operatively in communication with the server 700. One or more e-commerce web sites 725 may be operatively coupled to the network 710 and the server 700. One or more social media web sites 730 may also be operatively coupled to the network 710 and the server 700. The user devices 715a-715d (which may support the IVM interface 100 as is shown in FIG. 1 and the IVM interface of FIG. 2) may also be in communication with the social media sites 730 and the e-commerce web site 725. The server 700 may host the Vendto web site 719, execute the coordinator software module 717, and execute an IVM wizard 722 including a Secure Distribution section 721. The social media web sites may include Facebook™, Twitter™, and the like. The system 750 may further include one or more vendors that may be a physical faculty or merchant that may or may not have an associate web site, but may have connectivity to the network 710 and the server 700 for particular types of transactions. The architecture of FIG. 7 is illustrative and those skilled in the art will recognize that different configurations are possible.

FIG. 8 is a flow diagram for performing an exemplary process, the steps performed according to principles of the disclosure. At step 800, an Internet Vending publisher tool may be provided. The Internet Vending Machine Publishing Tool may create a web page that displays a plurality of products for purchase selected from a first web site associated with an affiliate merchant and at least one product selected from a second web site, the second web site associated with a publisher, wherein the publisher makes available digital content (e.g., media file, a video file, audio, streaming video, a file, text, code, or any combination thereof) or a product on the second web site for purchase. The web site may be constructed for a subscriber of the Vento system 750. The subscriber may be the publisher. Multiple web sites for multiple subscribers (i.e., multiple publishers) of the Vendto system may be built and published. At step 805, a first link may be sent to a device (perhaps using a SMS message) associated with a customer of the publisher wherein the first link is configured to link to a web page, the web page configured with at least one second link to a product or a service of the first web site and the web page further configured with at least one third link to a product or a service associated with the second web site. At step 810, a product purchase selection may be from the device. At optional step 815, which may be done as an independent step, the first link may be forwarded to a second device, so that a user at the second device may access the web page also.

At step 820, a product purchase at the first web site or the second web site may be facilitated based upon the product purchase selection, wherein the product purchase at the first web site is facilitated by unique identifier of the publisher associated with the at least one second link. When the publishing tool creates the web page (which may be an Internet Vending Machine having an Internet Vending machine Interface) the each of the second links may be modified to include an identified of the publisher (such as an account number, or other publisher identifier), so that whenever a user uses or selects any of the second links, the identity of the associated publisher is knowable to the affiliate merchant. In this way, sales for each publisher can be accounted for as needed. The publisher can access this information with each affiliate merchant as needed such as to aggregate sales with their own website, if desired. If there are multiple second links to different affiliate merchants, each link provides the identifier of the publisher to each affiliate merchant for accounting and/or identification purposes. If the web page is propagated to other users (such as in steps 825 and/or 830), sales may be attributed to the publisher, thereby potentially gaining more sales revenue for the publisher. At optional step 825, a request to share the link or share the web page may be received. This may be initiated at the device (e.g., device 200) by selecting a social site ICON (such as ICON 106a, 106B of FIG. 1). Social sites might include, e.g., Facebook™, Twitter™ or other social web sites. Alternatively, a request to share may be initiated by ICON 107 that request s that a share option (of either the first link or the web page of the IVM) by using a telephone number. That is, once the ICON 107 is activated, a user may than supply a telephone number of another device for sharing the link or the web site. In this way, propagation may occur to promote additional sales opportunity to other individuals, as one individual can then share to another individual the same link or web page. At step 830, the sharing of the first link or the web site associated with the publisher may be shared as requested.

The web page generated by the Internet Vending Machine Publishing Tool may be made available to multiple individuals who wish to become publishers. A subscription to the Vendto web service may be required. By becoming a “publisher,” any person can promote products of their own on their own “publisher” web site, and/or also promote products from one or more affiliate programs and receive sales credit which may be accounted for as if the sales were made from their own “publisher” web site. A further step of may include aggregating and reporting amounts for purchases made at the first web site (affiliate web site) and for purchases made at the second web site (publisher web site) so that sales totals and other financial statistics are shown on a common report. Any number of affiliate merchant web sites may be included in the web page published by each publisher of the Vendto system, 750.

FIG. 9 is a flow diagram for performing an exemplary process, the steps performed according to principles of the disclosure. At step 900, receiving at a portable device a message having a link to a web page may be received at a portable device. At step 905, the link may be activated such as by a user of the device. At step 910, a common display of a plurality of icons representing products or services may be received, each icon associated with a separate link to a product or service, wherein a subset of the separate links link to a first website and a second subset of the separate links link to a second website and a third subset of the separate links link to a third web site, wherein the second web site is a first affiliate web site and the third web site is a second affiliate web site. These steps may be performed by a computer or processor of the Vendto system 750 such as any device 715a-715d.

At step 915, accounting of the sales at the first web site and the second web site may be performed. This may include sales totals by individual campaigns by a publisher (different types of IVMs published for different marketing type campaigns by publisher). A common report may be issued for sales and sales statistics involving transactions at the first site and at the second site for each publisher. At step 925, the link may be shared with another portable device so that the another portable device may access the web page. Alternatively or in addition, the web page may be shared on a social media site so that other users may purchase products or services from each of the web sites.

While the disclosure has been described by way of illustrative examples, those skilled in the art will recognize that the principles of the disclosure can be practiced with modifications and in the spirit and scope of the appended claims. If there are any conflicts between this disclosure and any priority document, then this disclosure governs.

What is claimed is:

1. A computer implemented method for providing Internet based vending, the method comprising the steps of:
providing an Internet Vending publisher tool that creates a web page that displays a plurality of products for purchase selected from a first web site associated with an affiliate merchant and at least one product selected from a second web site, the second web site associated with a publisher, wherein the publisher makes available digital content or a product on the second web site for purchase;
sending a first link to a device associated with a customer of the publisher wherein the first link is configured to link to a web page, the web page configured with at least one second link to a products or a service of the first web site and the web page further configured with at least one third link to a product or a service associated with the second web site;
receiving a product purchase selection from the device; and
facilitating a product purchase at the first web site or the second web site based upon the product purchase selection, wherein the product purchase at the first web site is facilitated by a unique identifier of the publisher associated with the at least one second link,
wherein the providing, the sending, the receiving and the facilitating step are performed by a computer.

2. The computer implemented method of claim 1, wherein the device comprises a cell phone, a tablet computer, an electronic device or a personal computer.

3. The computer implemented method of claim 1, wherein the first link is sent using a short message service (SMS) message.

4. The computer implemented method of claim 1, wherein the Internet Publishing tool creates the web page that further displays a plurality of products for purchase selected from a third web site associated with a second affiliate merchant.

5. The computer implemented method of claim 1, further comprising the step of forwarding the first link from the device to a second device, wherein the second device is configured to permit a user of the second device to select the first link to access the web page to purchase a product at the first web site or the second web site.

6. The computer implemented method of claim 1, wherein the product is digital content.

7. The computer implemented method of claim 6, wherein the digital content is a media file, a video file, audio, streaming video, a file, text, code, or any combination thereof.

8. The computer implemented method of claim 1, wherein the at least one second link is a plurality of second links, each of the plurality of second links linking to a separate product or service for purchase.

9. The computer implemented method of claim 1, wherein the at least one third link is a plurality of third links, each of the plurality of third links linking to a separate product or service for purchase.

10. The computer implemented method of claim 1, further comprising the steps of:
receiving a request to share the web page on a social media web site; and
initiating sharing of the web page on a social media web site so that other individuals may access any of the products or services.

11. The computer implemented method of claim 1, further comprising the steps of:
receiving a request to share the first link with a second device using a telephone number; and
initiating sharing of the first link to the second device.

12. The computer implemented method of claim 1, wherein access to the link, product or service is controlled by a digital rights management technique so that access to the link, product or service is selectively granted or denied until an authentication of the accessing device or user is completed.

13. The computer implemented method of claim 1, further comprising the step of aggregating and reporting amounts for purchases made at the first web site and for purchases made at the second web site so that sales totals and other financial statistics are shown on a common report.

14. A system for providing Internet based vending comprising;
an Internet Vending publisher tool configured to create a web page that displays a plurality of products for purchase selected from a first web site associated with an affiliate merchant and at least one product selected from a second web site, the second web site associated with a publisher, wherein the publisher makes available digital content or a product on the second web site for purchase;
a component executable by a computer and embodied in a non-transitory medium to send a first link to a device associated with a customer of the publisher wherein the first link is configured to link to a web page, the web page configured with at least one second link to products or services of the first web site and the web page further configured with at least one third link to products associated with the second web site; and
a component executable by a computer and embodied in a non-transitory medium to facilitate a product purchase at the first web site or the second web site based upon a product purchase selection wherein the product purchase at the first web site is facilitated by unique identifier of the publisher associated with the at least one second link.

15. The system of claim 14, wherein the device comprises a cell phone, a tablet computer, an electronic device or a personal computer.

16. The system of claim 14, wherein the first link is sent using a short message service (SMS) message.

17. The system of claim 14, wherein the Internet Publishing tool creates the web page that further displays a plurality of products for purchase selected from a third web site associated with a second affiliate merchant, wherein each affiliate merchant has separate requirements for being a affiliate.

18. The system of claim 14, further comprising a component to forward the first link from the device to a second device, wherein the second device is configured to permit a user of the second device to select the first link to access the web page to purchase a product at the first web site or the second web site.

19. The system of claim 14, wherein the product is digital content and the digital content is configured to control access of the digital content by a digital rights management technique at the device that prevents access to the digital content until authorization has been received.

20. The system of claim 14, wherein the digital content is a media file, a video file, audio, streaming video, a file, text, code, or any combination thereof.

21. The system of 14, wherein the at least one second link is a plurality of second links, each of the plurality of second links linking to a separate product or service for purchase

22. The system of claim 14, wherein the at least one third link is a plurality of third links, each of the plurality of third links linking to a separate product or service for purchase.

23. The system of claim 14, further comprising:
a component to receive a request to share the web page on a social media web site;
a component to initiate sharing of the web page on a social media web site so that other individuals may access any of the products or services.

24. The system of claim 14, further comprising:
a component to receiving a request to share the first link with a second device using a telephone number; and
a component to initiate sharing of the first link to the second device.

25. A computer implemented method for providing Internet based vending comprising the steps of;
receiving at a portable device a message having a link to a web page;
activating the link; and
receiving a common display of a plurality of icons representing products or services, each icon associated with a separate link to a product or service, wherein a subset of the separate links link to a first website and a second subset of the separate links link to a second website and a third subset of the separate links link to a third web site, wherein the second web site is a first affiliate web site and the third web site is a second affiliate web site,
wherein the receiving step, the activating step and the receiving step are performed by a computer.

26. The computer implemented method of claim 25, further comprising accounting for sales for purchases at each web site and reporting totals and other statistics in a common report for transactions at each web site.

27. The computer implemented method of claim 25, further comprising sharing the link with another portable device so that the another portable device may access the web page.

28. The computer implemented method of claim 25, further comprising sharing the web page on a social media site so that other users may purchase products or services from each of the web sites.
